(19) United States
(12) Patent Application Publication
(10) Pub. No.: US 2008/0311814 A1
(43) Pub. Date: Dec. 18, 2008

(54) Activated bicomponent fibers and nonwoven webs

(75) Inventors: Matthew J. O'Sickey, Powhatan, VA (US); Jonathan E. Frost, Ada, MI (US)

Correspondence Address: Tessari & Associates, PLLC, 205 N. Monroe Street, Media, PA, 19063, US

(73) Assignee: Tredegar Film Products Corporation, Richmond, VA (US)

(21) Appl. No.: 12/214,059

(22) Filed: Jun. 16, 2008

Related U.S. Application Data
(60) Provisional application No. 60/934,885, filed on Jun. 15, 2007.

(51) Int. Cl. D04H 13/00; B29C 55/00

(52) U.S. Cl. 442/329; 264/229

(57) ABSTRACT

Methods of activating bicomponent elastic fiber nonwovens webs and laminates, and the resultant activated bicomponent elastic fiber nonwoven webs and laminates are disclosed, wherein the bicomponent elastic fiber nonwoven webs include a first material and a second material, wherein the first material has a lower yield point than the second material.

### RELATED APPLICATIONS

This application claims priority to U.S. Provisional Patent Application No. 60/934,885 filed Jun. 15, 2007.

### TECHNICAL FIELD

The disclosure relates to elastic fibers and nonwoven webs for use in articles such as diapers, sanitary napkins or incontinence pads, bandages or in general for other similar articles.

### BACKGROUND

Absorbent articles typically include a topsheet, a backsheet, and an absorbent core. In some absorbent articles, it is necessary or desirable to incorporate an elastic component into the article to provide improved fit or comfort to the wearer. For example, in diapers, the nonwoven should be able to stretch and have the ability to retract at least partially in order to maintain a snug fit around the user and, therefore, the diaper will be able to stay on and comfortable under the normal use and movement of a child. Elastic materials, however, typically do not have pleasant tactile properties and therefore are not generally preferred for use on skin contacting surfaces of such articles. Therefore, typically, elastic films are laminated to nonwoven webs to provide the desired tactile properties and at least some elasticity to the component of the article. The nonwoven webs are preferably soft and offer a pleasant tactile sensation when in direct contact with the skin. The nonwoven webs also add additional strength to composite materials. Additionally, an elastic/nonwoven laminate should have a pleasant tactile feel, be handled easily, and, in some instances, be breathable to provide comfort to the user.

Elastic composites typically comprise elastic nonwovens and/or layers of elastic film. In some applications, it may be desirable for the laminate to breathe to maintain comfort of the wearer; therefore, apertured elastic films may be used in the laminate. However, the apertures or holes may weaken the film and, when stretched, may constitute a site from where tears initiate and may further propagate in the film. Thin elastic films are desirable economically, but have limited strength and the strength is further limited by the holes provided to add breathability.

Elastic nonwovens are nonwoven webs made of elastic fibers, that is, fibers made from elastomeric resins. Some elastic nonwoven webs comprise bicomponent fibers, which contain both a nonelastic material and an elastic material. Some bicomponent fibers have an elastic core surrounded by a nonelastic sheath, and are said to provide an elastic fiber with improved tactile properties. The sheath of the bicomponent fiber may be chosen to enhance tactile feel to the skin, but may reduce the overall elastic properties of the fiber. In particular, the elasticity of the bicomponent fiber is well below the elasticity of the elastic core itself due to the inelasticity of the sheath. The core material of the fiber gives the required elasticity to the bicomponent fiber and consequently to the nonwoven web made up, at least in part, of the said fibers.

The core and the sheath can be concentric, or alternatively the core can be eccentric in the sheath or can be of the island kind, the islands being distributed symmetrically or otherwise in the sheath matrix. One method of making an elastic bicomponent fiber is described in U.S. Pat. No. 5,505,889, in this method, fibers comprising a core and a sheath are made by extrusion by fusion. The resulting fibers may be treated by conventional means, such as to form nonwoven webs.

There is a need for an elastic nonwoven with tear resistance, elasticity, and pleasing tactile properties. There is also a need for a method of producing an elastic nonwoven web with tear resistance, appropriate elasticity, and a soft feel.

### SUMMARY

Provided is a method for activating a bicomponent elastic fiber nonwoven web. A bicomponent elastic fiber nonwoven web has fibers comprising at least a first material and a second material in separate portions of the fibers. In embodiments of the method, the first material has a lower yield point than the second material. In certain embodiments, the second material may be an elastic material. The first material may be a nonelastic material or an elastic material. An embodiment of the method comprises activating the bicomponent elastic fiber nonwoven web such that at least a portion of the bicomponent fiber is plastically deformed. A further embodiment of the method comprises laminating an elastic film to the bicomponent elastic fiber nonwoven web. The lamination may occur either before or after the bicomponent elastic fiber nonwoven web is activated. The bicomponent elastic fiber nonwoven web may comprise fibers comprising a nonelastic material and an elastic material.

Embodiments further comprise a web comprising a bicomponent elastic fiber nonwoven web, wherein the bicomponent elastic fiber nonwoven web comprises fibers comprising a plastically deformed first material and a second material. In certain applications for the web, it may be desirable for the first material to be a nonelastic material and the second material to be an elastic material. In further embodiments of the web, the fibers of the bicomponent elastic fiber nonwoven web comprise a core comprising an elastic material and a plastically deformed sheath comprising a nonelastic material.

The web may further comprise an elastic film bonded to the bicomponent elastic nonwoven web to form a laminate. The laminate may comprise additional layers such as a second nonwoven web bonded to the elastic film. The second nonwoven may be activated and comprise plastically deformed fibers. Further, the second nonwoven web may be a bicomponent elastic fiber nonwoven web. The elastic films may be apertured or unapertured, as desired.

### BRIEF DESCRIPTION OF THE FIGURES

FIG. 1 is a perspective view of a conventional bicomponent fiber comprising an elastic core and a nonelastic sheath surrounding the elastic core;

FIG. 2 depicts an embodiment of the bicomponent fiber of FIG. 1 after activation, wherein the bicomponent fiber comprises a plastically deformed sheath and an elastic core that was not significantly permanently deformed by the activation process;

FIG. 3 is a graph of the tensile curve data for laminates comprising an elastic film and bicomponent elastic fiber nonwoven webs;

FIG. 4 is a graph of the same tensile curve data as shown in FIG. 3, but on a different scale;

FIG. 5 is a graph of the cross direction 100% cyclic tensile curve data for the same laminates;

FIG. 6 is a graph of the cross direction 200% cyclic tensile curve data for the same laminates.

### DESCRIPTION OF THE EMBODIMENTS

The disclosure provides a method comprising activating a bicomponent elastic fiber nonwoven web. The bicomponent elastic fiber nonwoven webs comprise at least a first material and a second material, wherein the first material has a lower yield point than the second material. In certain embodiments, the bicomponent elastic fiber nonwoven web comprises fibers comprising a core of an elastic material and a sheath of a nonelastic material. Further, a bicomponent elastic fiber nonwoven web may include fibers that have only one component or fibers that include additional components, such as a nonwoven web that comprises a combination of bicomponent elastic fibers and fibers that comprise substantially only one material and, optionally, an additive. Either the first material or the second material may comprise a polymer such as a thermoplastic polymer or an elastomer, for example.

As is known in the art, nonwoven webs are fibrous webs comprised of polymeric fibers arranged in a random or non-repeating pattern. For most of the nonwoven webs, the fibers are formed into a coherent web by any one or more of a variety of processes, such as spunbonding, meltblowing, bonded carded web processes, hyrdoentangling, etc., and/or by bonding the fibers together at the points at which one fiber touches another fiber or crosses over itself. The fibers used to make the webs may be a single component or a bi-component fiber as is known in the art and furthermore may be continuous or staple fibers.

The term “meltblown fibers” refers to fibers formed by extruding a molten thermoplastic material through a plurality of fine, usually circular, die capillaries as molten threads or filaments into a high velocity gas (e.g., air) stream that attenuates the filaments of molten thermoplastic material to reduce their diameter, which may be to a microfiber diameter. The term “microfibers” refers to small diameter fibers having an average diameter not greater than about 100 microns. Thereafter, the meltblown fibers are carried by the high velocity gas stream and are deposited on a collecting surface to form a web of randomly dispersed meltblown fibers.

The term “spunbonded fibers” refers to small diameter fibers that are formed by extruding a molten thermoplastic material as filaments from a plurality of fine, usually circular, capillaries of a spinneret with the diameter of the extruded filaments then being rapidly reduced as by, for example, eductive drawing or other well-known spunbonding mechanisms.

The term “unconsolidated” means the fibers have some freedom of movement and are not fixed in position with respect to the other fibers in the web. In other words, the fibers generally are not compacted together or fused.

By contrast, the term “consolidated” means the fibers are generally compacted, fused, or bonded, so as to restrict movement of the fibers individually. Consolidated fibers will generally have a higher density than unconsolidated fibers.

The term “unitary web” refers to a layered web comprising two or more webs of material, including nonwoven webs, that are sufficiently joined, such as by thermal bonding means, to be handled, processed, or otherwise utilized, as a single web.

When considering whether a material is a less elastic material, it may be either a nonelastic material or an elastic material that has a lower yield point than another materials contained within the fiber. The yield point of a material is defined as the stress at which a material begins to plastically deform or fractures. Prior to the yield point, the material will deform elastically and will substantially return to its original shape when the applied stress is removed. Once the yield point of a material is reached, some portion of the deformation will be plastic and, thus, permanent and non-reversible. As used herein, a “nonelastic material” is a material that, when stretched to 125% of its original length, will not recover more than 40% of its additional stretched length upon release of the stretching force. All other materials are considered to be elastic materials.

In certain embodiments, the bicomponent fibers may be considered generally to have a core and sheath structure. The resin compositions used for the core and the sheath may be any material that provides the desired properties to the bicomponent fiber. Such properties may include tactile properties, elastic properties, strength, as well as other properties. In certain embodiments, the sheath of a bicomponent fiber may comprise between 5 wt % and 80 wt % of the fiber, preferably the sheath may comprise between 10 wt. % and 30 wt % of the fibers, more preferably, the sheath may comprise from 10 wt % to 20 wt % of the fibers. In certain applications, it may be desirable for the sheath material to be a nonelastic material and the core to be an elastic material

As used herein, the term “polymer” includes homopolymers, copolymers, such as, for example, block, graft, random and alternating copolymers, terpolymers, etc., and blends and modifications thereof. Furthermore, unless otherwise specifically limited, the term “polymer” is meant to include all possible stereochemical configurations of the material, such as isotactic, syndiotactic and random configurations.

A thermoplastic polymer may be at least one polymer selected from polyethylene, copolymers of polyethylene, low density polyethylene, linear low density polyethylene, high density polyethylene, medium density polyethylene, polypropylene, copolymers of polypropylene, blends of polyethylene and polypropylene, random copolymer polypropylene, polypropylene impact copolymers, polyolefins, metallocene polyolefins, metallocene linear low density polyethylene, polyesters, copolymers of polyesters, plastomers, polyvinylacetates, poly(ethylene-co-vinyl acetate), poly(ethylene-co-acrylic acid), poly(ethylene-co-methyl acrylate), poly(ethylene-co-ethyl acrylate), cyclic olefin polymers, butadiene, polyamides, copolymers of polyamides, polystyrenes, polyurethanes, poly(ethylene-co-n-butyl acrylate), polylactic acid, nylons, rayon, cellulose, polymers from natural renewable sources, biodegradable polymers or blends thereof.

An elastic material may comprise at least one of styrenic block copolymers, thermoplastic polyolefins, thermoplastic polyurethanes, sequenced copolymers, poly(ethylene-butene), poly(ethylene-hexene), poly(ethylene-propylene), poly(ethylene-octene), poly(styrene-butadiene-styrene), poly(styrene-ethylene and butylene-styrene), poly(styrene-isoprene-styrene), a poly(ester ether oxide), a poly(ether oxide-amide), poly(ethylene-vinyl acetate), poly(ethylene-methylacrylate), poly(ethylene-acrylic acid), poly(ethylene-butyl acrylate), tetra-sequenced copolymers, (polyethylene-propylene)-styrene, polyolefins produced with a metallocene catalyst such as polyethylene, polypropylene, a polyester, a polyamide, or mixtures thereof.

Additionally, any of a variety of fillers or additives may be added to the polymers and may provide certain desired characteristics, including, but not limited to, roughness, anti-static, abrasion resistance, printability, writeability, opacity, processing aids, sealing aids, UV stabilizers, and color. Such fillers and additives are well known in the industry and include, for example, calcium carbonate (abrasion resistance), titanium dioxide (color and opacity) and silicon dioxide (roughness).

As used herein, the term “activating” or “activation” refers to a process of stretching a material beyond a point where its physical properties are changed. In the case of a nonwoven web, sufficient activation of the web will result in the nonwoven web being more extensible and/or improving its tactile properties. In an activation process, forces are applied to a material causing the material to stretch. A nonwoven web may be mechanically activated, for example. Mechanical activation processes comprise the use of a machine or apparatus to apply forces to the nonwoven web to cause stretching of the nonwoven web or fibers. Methods and apparatus used for activating nonwovens include, but are not limited to, activating the web through intermeshing gears or plates, activating the web through incremental stretching, activating the web by ring rolling, activating the web by tenter frame stretching, canted wheel stretchers, bow rollers, and activating the web in the machine direction between nips or roll stacks operating at different speeds to mechanically stretch the components, and combinations thereof. Examples of these processes are disclosed in U.S. Pat. No. 5,167,897; U.S. Pat. No. 5,156,793; U.S. Pat. No. 5,143,679; and European Patent Application No. 98108290.2, for example.

During activation, at least a portion of the bicomponent fibers in the nonwoven web is plastically deformed, for example; such plastic deformation may result in a reduction in the thickness of the nonelastic material, or a tearing or fracture of the nonelastic material, or other permanent deformation. The more elastic material may also be strained during mechanical activation and may or may not be plastically deformed. In particular, activating the bicomponent elastic fiber nonwoven web comprises applying tension to the first (relatively less elastic) material to stretch the first material beyond its yield point such that the first, or less elastic material is plastically deformed. The second material, that is, the material with the higher yield point, may or may not be substantially plastically deformed. In certain embodiments wherein the bicomponent fibers comprising a core and sheath structure, the sheath of the fiber may be plastically deformed during the activation process while the elastic core stretches, but is not permanently deformed and returns substantially to its original shape after the activation process.

A plastically deformed material, such as the plastically deformed sheath, is a material that has undergone non-reversible changes in physical properties in response to applied forces, such as an activation process. For example, a nonelastic thermoplastic polymer that has been stretched beyond its yield point displays plastic deformation including thinning or neck-in, strain hardening, and/or fracture. Depending on the type of material, size and geometry of the object, and the forces applied, various types of deformation may result. In a thermoplastic fiber, for example, permanent elongation, thinning or neck-in may occur when the material is stressed beyond the yield point.

Embodiments further comprise a web comprising a bicomponent elastic fiber nonwoven web, wherein the bicomponent elastic fiber nonwoven web comprises fibers comprising a plastically deformed first material and a second material. In certain applications for the web, it may be desirable for the first material to be a nonelastic material and the second material to be an elastic material. In further embodiments of the web, the fibers of the bicomponent elastic fiber nonwoven web comprise a core comprising an elastic material and a plastically deformed sheath comprising a nonelastic material.

The web may further comprise an elastic film bonded to the bicomponent elastic nonwoven web to form a laminate. The laminate may comprise additional layers such as a second nonwoven web bonded to the elastic film. The second nonwoven may be activated and comprise plastically deformed fibers. Further, the second nonwoven web may be a bicomponent elastic fiber nonwoven web. The elastic films may be apertured or unapertured, as desired.

As used herein, “laminate” and “composite” are synonymous. Both refer to a web structure comprising at least two webs or layers joined to form a multiple-layer unitary web. The webs may be coextruded or joined by a lamination process, such as adhesive lamination, thermal lamination, ultrasonic bonding, pressure lamination, and combinations. Adhesives used to form the laminate may be any of a large number of commercially available pressure sensitive adhesives, including water based adhesives such as, but not limited to, acrylate adhesives, for example, vinyl acetate/ethylhexyl acrylate copolymer which may be combined with tackifiers. Other adhesives include spray adhesives, pressure sensitive hot melt adhesives, or double sided tape.

When a force is applied to a material, initially the material undergoes elastic deformation. Elastic deformation is a reversible deformation such that,once the forces are no longer applied, the material returns to its original shape. Nonelastic thermoplastic polymers will undergo a moderate elastic deformation. The elastic deformation range ends when the material reaches its yield point and at this point plastic deformation begins. Plastic deformation is not reversible. A material in the plastic deformation range will first have undergone elastic deformation, which is reversible, so the object may partially return to its original shape after plastic deformation. Thermoplastic polymers typically have a relatively large plastic deformation range.

Under tensile stress, a plastically deformed material may be characterized by strain hardening, thinning or neck-in, and finally, fracture. During strain hardening the material becomes stronger. Thinning is indicated by a reduction in thickness of a layer, such as the sheath of a core/sheath bicomponent fiber. Neck-in is indicated by a reduction in cross-sectional area of a material, such as the thermoplastic fibers. During neck-in, the material can no longer withstand the maximum stress and the strain in the specimen rapidly increases. Fracture is also a type of irreversible plastic deformation.

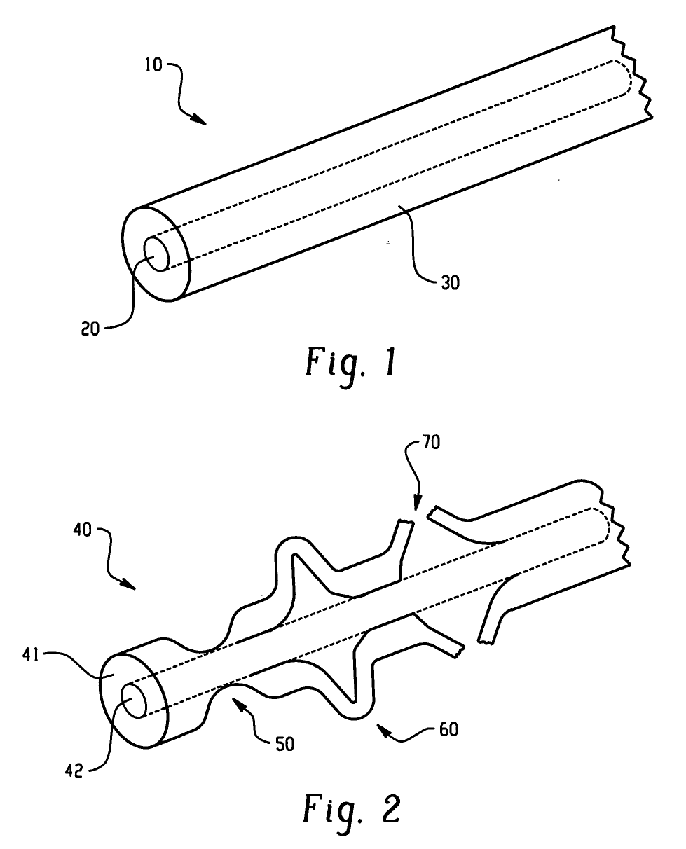

As shown in FIG. 1, a bicomponent elastic fiber 10 typically includes a core 20 comprising an elastic material and a sheath 30 comprising a less elastic material or a nonelastic material surrounding the core. However, a bicomponent elastic fiber comprising a core of a nonelastic fiber and a sheath of an elastic fiber are also known and can be used to advantage. It should be understood that it is not necessary that the sheath totally surround the core of the bicomponent fiber as generally shown in FIG. 1.

After activation as shown in FIG. 2, portions of the sheath 41 are plastically deformed. In particular, the sheath 41 may contain portions that are thinned as at 50, puckered and separated from the elastic core 42 as at 60, or torn as at 70, or combinations thereof. The tactile properties, particularly softness of the bicomponent elastic fiber web may be improved or enhanced by the activation. Furthermore, the elastic properties of the bicomponent elastic fiber web, or the laminate comprising such a web may be improved by the activation process.

### EXAMPLES

### Materials

The bicomponent elastic nonwoven web used in both Sample ID 34335 and Sample ID 34475 is available from Fiberweb and sold under the tradename DREAMEX™. The nonwoven web had a basis weight of 25 grams per square meter (“GSM”). The elastic polymer film used in both Sample ID 34335 and Sample ID 34475 is available from Tredegar Film Products Corporation, Richmond, Va. under the tradename ExtraFlex™ CEX-812. The elastic film of these examples has a basis weight of 57 GSM. The laminates were formed by an adhesive lamination process using a hot melt adhesive spray available from National Starch & Chemicals under Product No. 34-5647. The adhesive were applied films at 5 GSM.

### Activation

The bicomponent elastic nonwoven web was activated between intermeshing gears having a depth of engagement of 165 mils. The activation plastically deformed the sheath of the bicomponent elastic nonwoven web.

### Tri-Laminates

Multiple samples of each of two different types of tri-laminates were produced for testing. The first set of tri-laminate webs (designated by Sample ID 34335 in the tables and Figures) were formed by adhesively laminating an activated DREAMEX™ nonwoven webs on either side of the CEX-812 elastic film. The second set of tri-laminate webs (designated by Sample ID 34475 in the tables and Figures) were formed by adhesively laminating an unactivated DREAMEX™ nonwoven web on either side of the CEX-812™ elastic film. The difference between the two tri-laminates was the activated and unactivated bicomponent elastic nonwoven webs in the outer layers. Table 1 describes each layer of the tested tri-laminates.

TABLE 1

| Sample | | | |
|---|---|---|---|
| ID | Layer 1 | Layer 2 | Layer 5 |
| 34355 | Bicomponent | Tredegar | Bicomponent |
| | elastic | CEX-812 | elastic |
| | nonwoven | elastic | nonwoven |
| | web, CD | film, 57 | web, CD |
| | activated | GSM | activated |
| | 165 mils | | 165 mils |
| 34475 | Bicomponent | Tredegar | Bicomponent |
| | elastic | CEX-812 | elastic |
| | nonwoven | elastic | nonwoven |
| | web | film, 57 | web |
| | | GSM | |

### Physical Properties

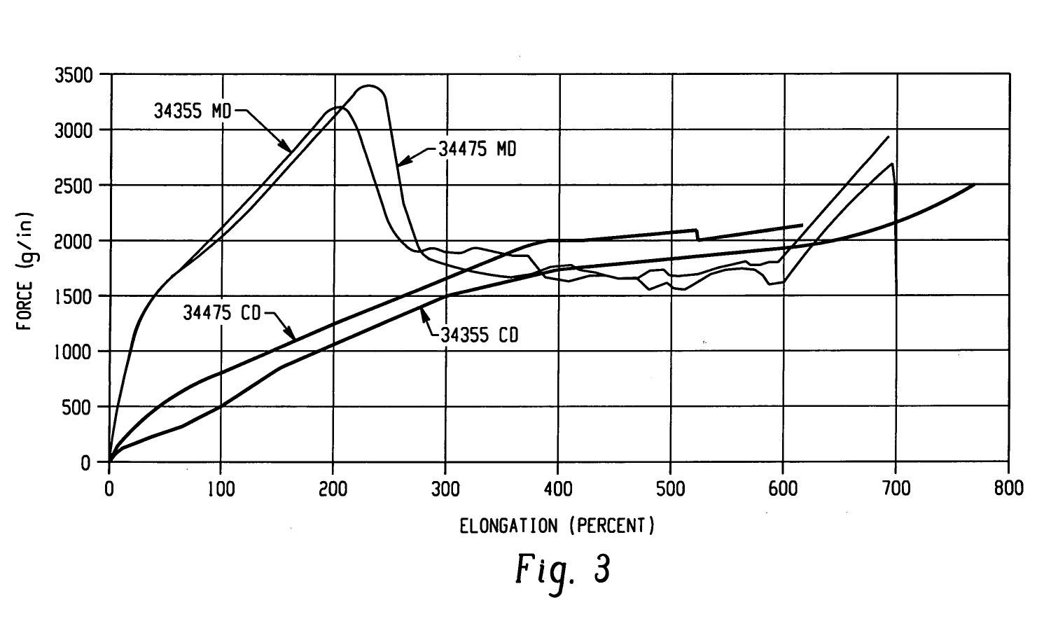

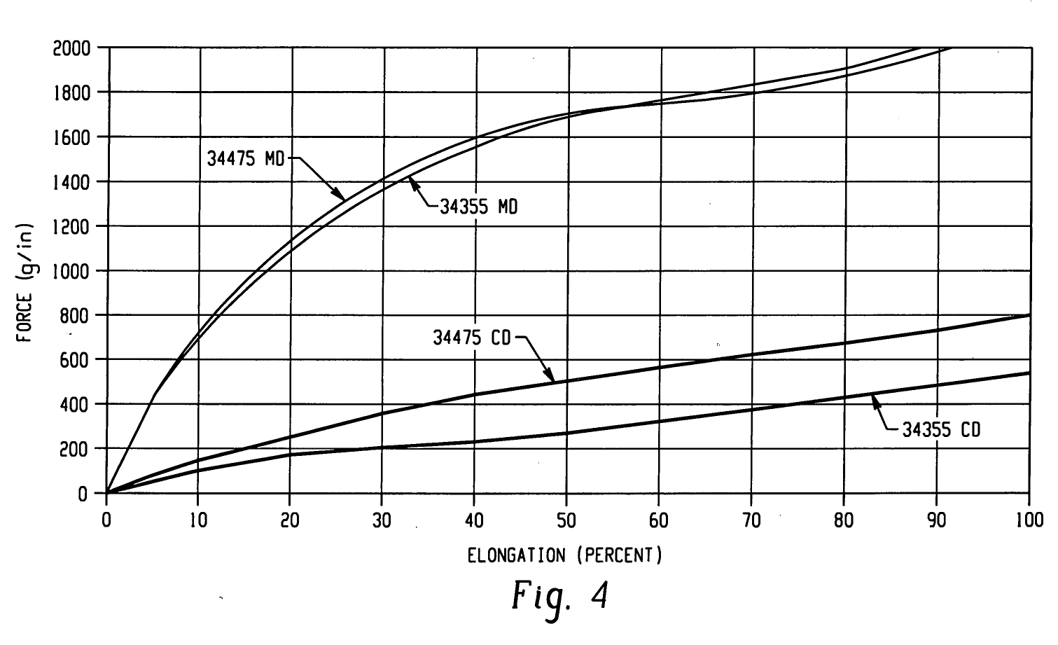

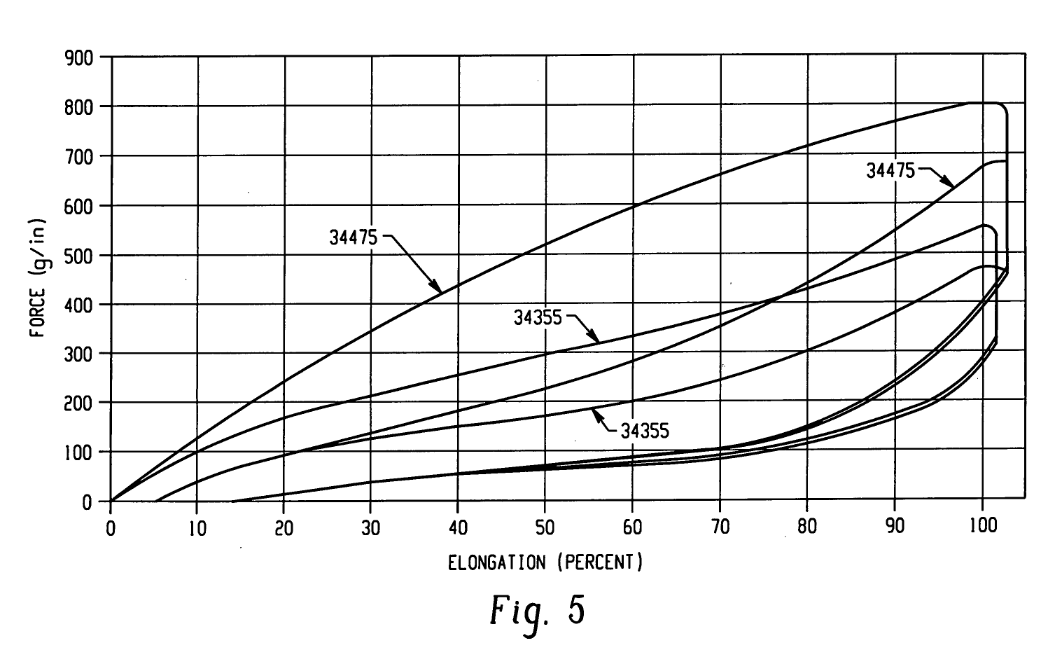

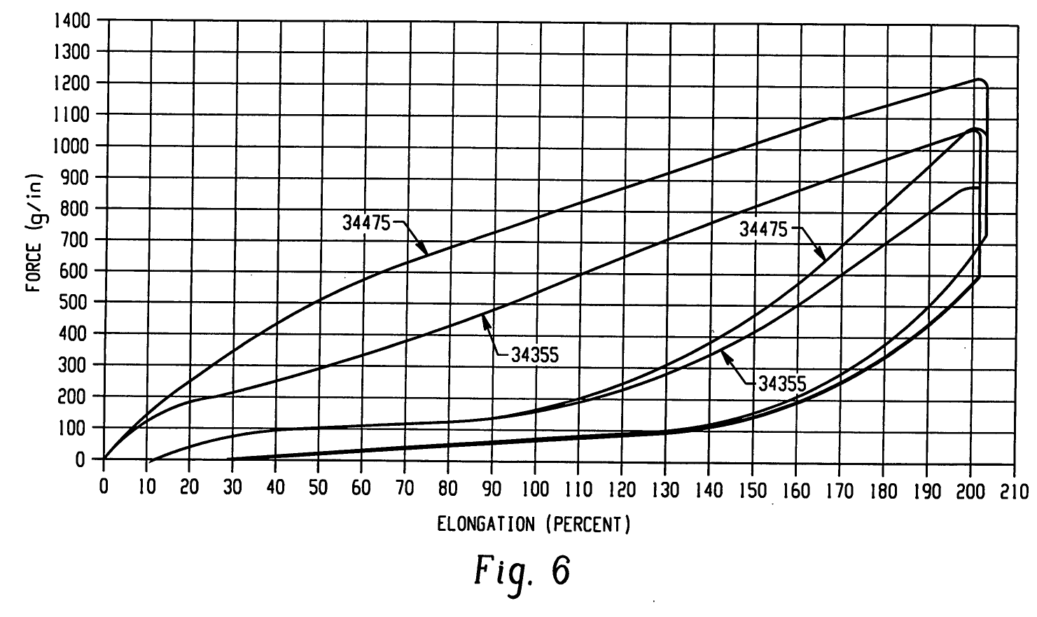

The physical properties of the tri-laminates were measured. Table 2 and FIGS. 3 through FIG. 6 provide the average results of the testing completed on each set of tri-laminates. FIG. 3 is a graph of the tensile curve data in both the machine direction and the cross direction for Sample ID 34355 and Sample ID 34475. FIG. 4 is a graph of the same tensile curve data, but the scale of the x-axis is 0 to 100% elongation. FIG. 5 is a graph of the cross direction 100% cyclic tensile curve data for Sample ID 34355 and Sample ID 34475. FIG. 6 is a graph of the cross direction 200% cyclic tensile curve data for Sample ID 34355) and Sample ID 34475.

TABLE 2

| | Sample ID 34355 | Sample ID 34755 |
|---|---|---|
| Property | (activated nonwovens) | (comparative) |
| Basis Weight (GSM) | 127 | 121 |
| MD Trapezoid Tear | 5.71 | 5.27 |
| CD Trapezoid Tear | 8.94 | 8.91 |
| Circular Bend Stiffness | 113 | 132 |
| (g) | | |
| Bond Strength (side 1; | 505 | 432 |
| g/in) | | |
| Bond Strength (side 2; | 519 | 410 |
| g/in) | | |
| Low Load Thickness | 0.44 | 0.44 |
| (mm) | | |
| Coefficient of Friction | 0.273 | 0.273 |
| (MD) | | |
| Coefficient of Friction | 0.257 | 0.275 |
| (CD) | | |

The date in Table 2 and FIGS. 3-6 demonstrates several important features. The laminates comprising the activated bicomponent elastic fiber nonwoven webs (Samples ID 34355) had higher average tear resistance in both the machine direction (MD); and cross direction (CD). Moreover, CD activation of the nonwoven significantly reduces true CD hysteresis via reducing the force required to extend the first cycle pull. Accordingly, activation of the bicomponent elastic fiber nonwoven webs resulted in improved stretch properties and improved tear resistance in the laminate.

The coefficient of friction and thickness tests demonstrate differences in softness compared to unactivated bicomponent elastic nonwoven webs. This is verified when compared to the more subjective comparisons such as compressibility and hand feel that are noticeably better for an activated bicomponent elastic web than for the unactivated web.

1. A method, comprising:
activating a bicomponent elastic fiber nonwoven web, wherein the bicomponent elastic fiber nonwoven web comprises fibers comprising a first material and a second material, wherein the first material has a lower yield point than the second material.

2. The method of claim 1, wherein the first material is a nonelastic material and the second material is an elastic material.

3. The method of claim 1, wherein activating the bicomponent elastic fiber nonwoven web comprises stressing the first material beyond its yield point.

4. The method of claim 1, wherein the fibers comprise a sheath of the first material and a core of the second material.

5. The method of claim 1, wherein activating comprises at least one process selected from activating the web through intermeshing gears or plates, activating the web through incremental stretching, activating the web by ring rolling, activating the web by tenter frame stretching, and activating the web in the machine direction between nips or roll stacks operating at different speeds.

6. The method of claim 2, wherein the second material comprises a elastomer selected from styrenic block copolymers, thermoplastic polyolefins, thermoplastic polyurethanes, sequenced copolymers, poly(ethylene-butene), poly(ethylene-hexene), poly(ethylene-propylene), poly(ethylene-octene), poly(styrene-butadiene-styrene), poly(styrene-ethylene and butylene-styrene), poly(styrene-isoprene-styrene), a poly(ester ether oxide), a poly(ether oxide-amide), poly(ethylene-vinyl acetate), poly(ethylene-methylacrylate), poly(ethylene-acrylic acid), poly(ethylene-butyl acrylate), tetra-sequenced copolymers, (polyethylene-propylene)-styrene, polyolefins produced with a metallocene catalyst such as polyethylene, polypropylene, a polyester, a polyamide, and mixtures thereof.

7. The method of claim 2, wherein the nonelastic material comprises a polymer selected from polyethylene, copolymers of polyethylene, low density polyethylene, linear low density polyethylene, high density polyethylene, medium density polyethylene, polypropylene, copolymers of polypropylene, blends of polyethylene and polypropylene, random copolymer polypropylene, polypropylene impact copolymers, polyolefins, metallocene polyolefins, metallocene linear low density polyethylene, polyesters, copolymers of polyesters, plastomers, polyvinylacetates, poly(ethylene-co-vinyl acetate), poly(ethylene-co-acrylic acid), poly(ethylene-co-methyl acrylate), poly (ethylene-co-ethyl acrylate), cyclic olefin polymers, butadiene, polyamides, copolymers of polyamides, polystyrenes, polyurethanes, poly(ethylene-co-n-butyl acrylate), polylactic acid, nylons, polymers from natural renewable sources, biodegradable polymers and mixtures and blends thereof.

8. The method of claim 1, further comprising the step of laminating the bicomponent elastic fiber web to an elastic film.

9. The method of claim 8, wherein said lamination step occurs after said activation.

10. A web, comprising:
a bicomponent elastic fiber nonwoven web, wherein the bicomponent elastic fiber nonwoven web comprises fibers comprising a plastically deformed first material and a second material, wherein the first material has a lower yield point than the second material.

11. The web of claim 10, wherein the first material is a nonelastic material.

12. The web of claim 10, wherein the fibers comprise a core comprising an elastic material and a plastically deformed sheath comprising a nonelastic material.

13. The web of claim 10, further comprising an elastic film bonded to the bicomponent elastic nonwoven web.

14. The web of claim 13, comprising a second nonwoven web bonded to the elastic film.

15. The web of claim 14, wherein the second nonwoven web comprises plastically deformed fibers.

16. The web of claim 14, wherein the second nonwoven web is a bicomponent elastic fiber nonwoven web.

17. The web of claim 11, wherein the elastic material comprises a elastomer selected from styrenic block copolymers, thermoplastic polyolefins, thermoplastic polyurethanes, sequenced copolymers, poly(ethylene-butene), poly(ethylene-hexene), poly(ethylene-propylene), poly(ethylene-octene), poly(styrene-butadiene-styrene), poly(styrene-ethylene and butylene-styrene), poly(styrene-isoprene-styrene), a poly(ester ether oxide), a poly(ether oxide-amide), poly(ethylene-vinyl acetate), poly(ethylene-methylacrylate), poly(ethylene-acrylic acid), poly(ethylene-butyl acrylate), tetra-sequenced copolymers, (polyethylene-propylene)-styrene, polyolefins produced with a metallocene catalyst such as polyethylene, polypropylene, a polyester, a polyamide, and mixtures thereof.

18. The web of claim 11, wherein the nonelastic material comprises a polymer selected from polyethylene, copolymers of polyethylene, low density polyethylene, linear low density polyethylene, high density polyethylene, medium density polyethylene, polypropylene, copolymers of polypropylene, blends of polyethylene and polypropylene, random copolymer polypropylene, polypropylene impact copolymers, polyolefins, metallocene polyolefins, metallocene linear low density polyethylene, polyesters, copolymers of polyesters, plastomers, polyvinylacetates, poly(ethylene-co-vinyl acetate), poly(ethylene-co-acrylic acid), poly(ethylene-co-methyl acrylate), poly(ethylene-co-ethyl acrylate), cyclic olefin polymers, butadiene, polyamides, copolymers of polyamides, polystyrenes, polyurethanes, poly(ethylene-co-n-butyl acrylate), polylactic acid, nylons, polymers from natural renewable sources, biodegradable polymers and mixtures and blends thereof.

19. The web of claim 25, wherein the elastic film is apertured.

20. The web of claim 25, wherein the elastic film is unapertured.
